(19) United States
(12) Patent Application Publication
(10) Pub. No.: US 2016/0371609 A1
(43) Pub. Date: Dec. 22, 2016

(54) PARKING LOT MANAGEMENT

(71) Applicant: Robert Bosch GmbH, Stuttgart (DE)

(72) Inventor: Stefan Nordbruch, Kornwestheim (DE)

(21) Appl. No.: 15/180,177

(22) Filed: Jun. 13, 2016

(30) Foreign Application Priority Data
Jun. 17, 2015 (DE) 10 2015 211 123.7

(51) Int. Cl. G06Q 10/02

(52) U.S. Cl. CPC G06Q 10/02; G06Q 2240/00

(57) ABSTRACT

A method for managing a parking lot having parking spaces includes steps of scanning the parking lot in the area of multiple parking spaces using a sensor, of determining, on the basis of the scan, at which locations of the scanned area motor vehicles are located, and of determining a parking space of the parking lot that is available for parking another motor vehicle.

### CROSS REFERENCE

The present application claims the benefit under 35 U.S.C. §119 of German Patent Application No. DE 102015211123.7 filed on Jun. 17, 2015, which is expressly incorporated herein by reference in its entirety.

### FIELD

The present invention relates to a parking lot management. The present invention relates in particular to the management of a parking lot having multiple parking spaces for parking vehicles.

### BACKGROUND INFORMATION

A parking lot comprises multiple parking spaces, which are designed for parking respectively one motor vehicle. In order to be able to manage the parking lot, occupancy states of the individual parking spaces are scanned, and a central management device processes the occupancy states, usually on the basis of a site map of the parking spaces associated with the occupancy states. For this purpose, a dedicated parking lot sensor is usually assigned to each parking space.

The parking lot sensors may be disposed above or below the motor vehicle. Particularly if the parking lot is in the open, it is alternatively possible to use a parking lot sensor that scans multiple parking spaces from a greater height.

These systems usually reach their limit if a parking lot is to be managed in which the individual parking spaces are not marked. The maximum capacity of the parking lot then depends on how tightly the individual motor vehicles are being parked in the parking lot and in which order the parking spaces are occupied. Such parking lots are often public, and it is not always the case that fees are collected for parking a motor vehicle.

The present invention has the objective of providing an improved technology for managing a parking lot.

### SUMMARY

A method for managing a parking lot having parking spaces includes steps of scanning the parking lot in the area of multiple parking spaces using a sensor, of determining, on the basis of the scan, at which locations of the scanned area motor vehicles are located, and of determining a parking space of the parking lot that is available for parking another motor vehicle. Preferably, multiple, ideally all, parking spaces are determined that are available for additional motor vehicles.

By using only one sensor for scanning multiple parking spaces, it is possible to reduce a number of sensors that is required for scanning all parking spaces. This makes it possible to save investment costs. By reducing the number of sensors, it is also possible to reduce an expenditure for communication connections between the individual sensors and a processing device.

Usually, it is possible to park exactly one motor vehicle in each parking space. In a preferred specific embodiment, however, at least one of the parking spaces is designed for parking multiple motor vehicles. The number of motor vehicles that are able to fit in this parking space depends on the dimensions of the parking space, of the individual motor vehicles, and on the arrangement or orientation of the motor vehicles in the parking space. In one especially preferred specific embodiment, the motor vehicles may be arranged freely in the parking space. A marking that would indicate to a driver of a motor vehicle where exactly he may park his motor vehicle is usually not provided in this context. Nevertheless, it is possible to determine on the basis of the scan whether an additional motor vehicle may be parked in a parking space, in which one or multiple motor vehicles are already located.

In another specific embodiment, a number of parking spaces of the parking lot is determined which are available for parking additional motor vehicles. For this purpose, it is possible to take into account that for example no blockage situation arises among parked motor vehicles, that entry or emergency routes adhere to specified dimensions and/or that a specified density of motor vehicles in the parking lot is not exceeded.

A computer program product includes program code means for carrying out the method described when the computer program product runs on a processing device or is stored on a computer-readable data carrier.

A device for managing a parking lot having multiple parking spaces includes a sensor for scanning the parking lot in the area of multiple parking spaces using a sensor, a processing device, which is designed to determine, on the basis of the scan, at which locations of the scanned area motor vehicles are located, and to determine a parking space of the parking lot that is available for parking another motor vehicle.

The device may be used for managing parking lots both with or without marked boundaries of parking spaces for respectively one motor vehicle. Thus, for example, it is also possible to use a parking space that is designed for parking a freight vehicle for one or multiple passenger cars.

It is especially preferable that the sensor is disposed above the parking spaces. It is preferable in particular that the sensor is mounted at a sufficient height in order to scan multiple parking spaces from a bird's eye view. For this purpose, the sensor may be fastened for example on a post, a pillar, a higher building section or another elevated installation.

In one specific embodiment, the sensor is movable in a horizontal direction across the parking lot. Consequently, it is possible to use the sensor for scanning multiple groups of parking spaces. For example, the sensor may be attached to a drone that is able to be guided across the parking lot in the horizontal direction. In another specific embodiment, the sensor is fastened on a cable system so as to be able to be pulled in the horizontal direction across the parking lot.

In another specific embodiment, multiple sensors are provided that are able to scan multiple parking spaces of the parking lot. In this instance, the scanning ranges of the individual sensors may overlap.

In yet another specific embodiment, the sensors use different scanning principles. For example, one of the sensors may operate on the basis of radar, another on the basis of lidar, yet another on the basis of ultrasound or an optical scan.

### BRIEF DESCRIPTION OF THE DRAWING

The present invention is described in more detail with reference to the figure.

FIG. 1 shows a parking lot having a management device.

### DETAILED DESCRIPTION OF EXAMPLE EMBODIMENTS

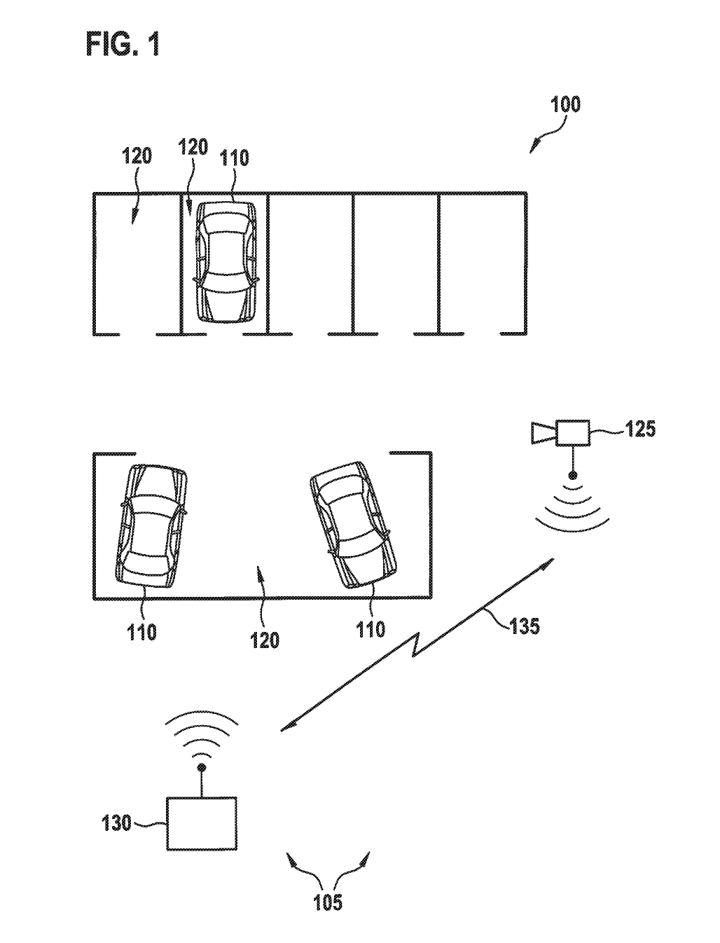

FIG. 1 shows a parking lot 100 having a device 105 for managing the parking lot 100. Device 105 is in particular designed to determine where in the area of parking lot 100 motor vehicles 110 are already located and where there is still accommodation capacity for parking another motor vehicle 110. Parking lot 100 comprises multiple parking spaces 120, which, as in the upper portion of the representation of FIG. 1, may be assigned respectively to one motor vehicle 110 or which, as in the lower portion of FIG. 1, are able to accommodate multiple motor vehicles 110. In the latter case, no markings are usually provided along which a parked motor vehicle 110 would have to be oriented. The lower parking space 120 may therefore be occupied in various ways by different numbers of motor vehicles 110. It is also possible that parking lot 100 only represents one single parking space 120, on which motor vehicles 110 may be parked as desired by the drivers.

In a first specific embodiment, device 105 is to identify one or multiple parking spaces 120 that are available for parking another motor vehicle 110. In another specific embodiment, it is also possible to determine a number of the available parking spaces 120. This number may be represented for example by way of a display board outside of parking lot 100. In yet another specific embodiment, device 105 is designed to prepare a representation of parking lot 100, which shows where motor vehicles 110 are located and where additional motor vehicles 110 may be parked in parking spaces 120.

For this purpose, device 105 includes at least one sensor 125, which is preferably designed to scan multiple parking spaces 120. It is also possible for multiple sensors 125 to be provided which preferably each are able to scan multiple parking spaces 120. Each of sensors 125 may use an arbitrary scanning principle, for example optically in the visible or in the infrared range, by radar, lidar, ultrasound or by laser. In particular, different sensors 125 may use different scanning principles in order to increase a scanning reliability. In addition, it is possible for scanning ranges of different sensors 125 to overlap partially or entirely.

It is preferable that at least one of sensors 125 is situated above parking spaces 120 so as to be better able to scan multiple parking spaces 120 from the bird's eye view. For example, sensor 125 may be mounted on a lamp post, a pole, a pillar or a higher portion of a building. Sensor 125 may also be situated so as to be displaceable in the horizontal direction across parking lot 100. For this purpose, sensor 125 may be mounted on a cable system that is strung across parking lot 110, or sensor 125 may be transported by a flying drone. For this purpose, the mobility may be made possible in one or two degrees of freedom, that is, in particular along a straight line or in a plane. A vertical mobility of sensor 125 may also be implemented.

Device 105 furthermore includes a processing device 130, which is connected to sensor 125 via a communication network 135. Communication network 135 may be wired or wireless, or a combination of wireless and wired technologies may be used. One or multiple wireless gateways may be used for this purpose.

Processing device 130 is designed to scan, if possible, the entire parking lot 100 or all provided parking spaces 120 using the at least one sensor 125 and to determine the occupancy of parking lot 100 on the basis of the scan. In this context, it is possible to prepare a representation, in particular a graphical representation that reflects the occupancy conditions of parking lot 100. It is also preferable that a parking space 120 that is available for accommodating another motor vehicle 110 is identified. For this purpose, specific assumptions may be made that are to ensure an orderly operation of parking lot 100. For example, a minimum spacing between individual motor vehicles 110 maybe specified. Furthermore, a minimum curve radius maybe assumed when maneuvering a motor vehicle 110. Additionally, specified parts of motor vehicle 100 may be provided as traffic zones in which no motor vehicle 110 may be parked. A parking space 120 that is available for parking another motor vehicle 110 must be configured in such away that the additional motor vehicle 110 does not impede any other motor vehicles 110. If, for example, in the representation of FIG. 1, another motor vehicle were parked in the lower parking space 120 between the two motor vehicles 110 already parked there, then there would be the danger that one of the previously parked motor vehicles 110 would no longer be able to leave parking space 120 safely. The parking space 120 represented in the lower portion may therefore count as already completely occupied even if in actual practice a driver willing to take a risk could park his motor vehicle 110 there. Furthermore, a particularly small motor vehicle 110 could also find room at the indicated location without difficulty.

The present invention is suitable both for parking lots 110 having marked parking spaces 120 as well as for parking lots 110 without marked parking spaces 120. The parking lot 100 in this context may be a parking garage, an underground parking facility or an open area.

What is claimed is:

1. A method for managing a parking lot having parking spaces, the method comprising:
scanning the parking lot in an area of multiple parking spaces using a sensor;
determining, based on the scan, at which locations of the scanned area motor vehicles are located; and
determining a parking space of the parking lot, which is available for parking another motor vehicle.

2. The method as recited in claim 1, wherein at least one of the parking spaces is designed for parking multiple motor vehicles.

3. The method as recited in claim 2, wherein the motor vehicles may be arranged freely in the at least one of the parking space.

4. The method as recited in claim 1, further comprising:
determining a number of the parking spaces of the parking lot which are available for parking additional motor vehicles.

5. A non-transitory computer-readable data carrier storing program code for managing a parking lot having parking spaces, the program code, when executing on a processing device, causing the processing device to perform:
scanning the parking lot in an area of multiple parking spaces using a sensor;
determining, based on the scan, at which locations of the scanned area motor vehicles are located; and
determining a parking space of the parking lot, which is available for parking another motor vehicle.

6. A device for managing a parking lot having multiple parking spaces, the device comprising:
a sensor for scanning the parking lot in an area of multiple parking spaces; and
a processing device designed to determine, based on the the scan, in which locations of the scanned area motor vehicles are located, and to determine a parking space of the parking lot which is available for parking another motor vehicle.

7. The device as recited in claim 6, wherein the sensor is situated above the parking spaces.

8. The device as recited in claim 6, wherein the sensor is movable in the horizontal direction above the parking lot.

9. The device as recited in claim 6, wherein multiple sensors are provided.

10. The device as recited in claim 9, wherein the sensors use different scanning principles.
